(19) United States
(12) Patent Application Publication
(10) Pub. No.: US 2018/0060813 A1
(43) Pub. Date: Mar. 1, 2018

(54) AUTONOMOUS DELIVERY VEHICLE SYSTEM

(71) Applicant: Ford Global Technologies, LLC, Dearborn, MI (US)

(72) Inventor: Scott Aaron Ford, Coral Gables, FL (US)

(73) Assignee: Ford Global Technologies, LLC, Dearborn, MI (US)

(21) Appl. No.: 15/244,495

(22) Filed: Aug. 23, 2016

(51) Int. Cl. G06Q 10/08; H04W 4/00

(52) U.S. Cl. CPC G06Q 10/0838; G06Q 2220/10; G06Q 10/08355; H04W 4/008

(57) ABSTRACT

An autonomous delivery vehicle system is provided. The system includes a security key transmitter configured to provide a security key to a secure facility server. Where the security key is valid, two-way communication is established between the delivery vehicle system and the secure facility server. The delivery vehicle system transmits lading information reflective of goods to be delivered or picked up. The secure facility server transmits instructions responsive to valid lading information.

### BACKGROUND

Secure facilities are often fenced in with access available only through a delivery gate. The delivery or pickup of goods in secure facilities, for example manufacturing facilities or government facilities, can be problematic. Once authorized to enter the secure facility, delivery drivers may not be familiar with the layout of the facility, or may have problems navigating to the proper delivery location especially where there are multiple locations to load or unload. Further, problems may arise when goods arrive at an unloading area such as a loading dock and the goods are either not expected or another vehicle is making a delivery at that same loading dock.

### BRIEF DESCRIPTION OF THE DRAWINGS

FIG. 1 illustrates an example delivery vehicle capable of transmitting lading information and receiving delivery/pickup information from a secure facility server.

FIG. 2 is a block diagram of an example delivery vehicle system that may be used with the delivery vehicle of FIG. 1.

FIG. 3 is a flowchart of an example process that may be executed by one or more of the components of the delivery vehicle system of FIG. 2.

### DETAILED DESCRIPTION

As described, upon arrival of a delivery vehicle to a security gate, the delivery vehicle may transmit a security key to a secure facility server. The security key is an electronic code that is unique to the delivery vehicle that may be verified. If the security key is valid, two-way communication is established between the secure facility server and a delivery vehicle system. If the security key is not valid, on-site security at the secure facility may be alerted. Where two-way communication is established the delivery vehicle system may transmit lading information to the secure facility server. The lading information is stored on a vehicle system in memory. The lading information may include information related to the shipper of goods (and the carrier of the goods if different from the shipper) as well as the type, quantity and destination of the goods. Alternately, the lading information may reflect goods to be picked up from the secure facility. The secure facility server verifies that the lading information matches predetermined delivery/pickup information. If the lading information does not match the predetermined delivery/pickup information on-site security may be notified. If the lading information does match the predetermined delivery/pickup information, the secure facility gate is opened, and instructions in the form of a designated location and/or routing information is provided to the delivery vehicle system by the secure facility server. The instructions may identify the designated location as a waiting area or an unloading/loading location or area. The routing information may provide a specific route to the designated location. The waiting area option may be selected if the information from the secure facility server shows that the unloading/loading area is occupied. Upon arrival at the waiting area the secure facility server may then again communicate with the delivery vehicle system so that further instructions may be provided, for example instructions to proceed to an unloading/loading area.

The delivery vehicle 100 carrying the goods to be delivered (or to be picked up) may incorporate a delivery vehicle system 110. An exemplary delivery vehicle system includes a number of components such as a two-way communication interface 125 and a processing/memory device 130. The processing/memory device 130 may recognize that a security key should be delivered to a secure facility server 105 for authentication. The security key may be transmitted by security key transmitter 140. The processing/memory device 130 may also instruct two-way communication interface 125 to transmit lading information to the secure facility server 105. Two-way communication interface 125 may receive instructions from the secure facility server 105 and processing/memory device 130 may interface with navigation system 120 to undertake those instructions. The instructions may identify a designated unloading/pickup area and/or may include routing information.

The systems shown in the Figures may take many different forms and include multiple and/or alternate components. The exemplary components illustrated are not intended to be limiting. Indeed, additional or alternate components may be used.

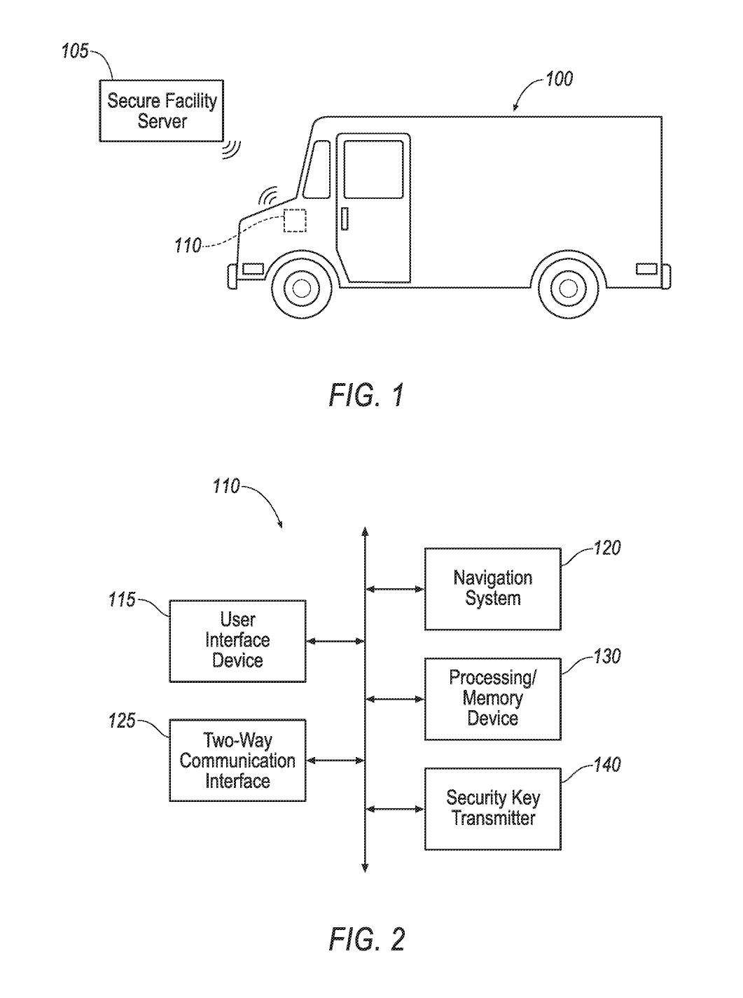

As illustrated in FIG. 1, a delivery vehicle 100, upon arrival at a security gate for a secure facility, may be in communication with a secure facility server 105. The delivery vehicle 100 may arrive to the secure facility in an autonomous mode or in a non-autonomous mode. Upon arrival at the gate, a security key may be transmitted to the secure facility server 105 from security key transmitter 140. The security key may be delivered actively or passively. The security key may be delivered by a Near Field Communication (NFC) device or by a RF device. The secure facility server 105 in turn validates the security key.

If the security key is not valid the secure facility server 105 may notify on-site security at the secure facility that an unauthorized delivery vehicle is at the security gate. On-site security may address the situation of an unauthorized vehicle per any protocols of the secure facility. If the security key is authenticated by the secure facility server, two-way communication may be initiated between the delivery vehicle system 110 and the secure facility server 105. The secure facility server may include delivery information reflective of all authorized delivery vehicles and the goods that are expected for a given time period as well as all pickup information. For example, the secure facility server may have predetermined information that includes an identification of authorized delivery vehicles expected in a given work day, the goods contained on those vehicles, the shipper of those goods as well as the carrier being used to ship the goods. The inverse information may be provided where the delivery vehicle is picking up goods.

Upon establishing a two-way communications link between the two-way communication interface 125 of the delivery vehicle system 110 and the secure facility server 105, upon request from the facility server 105, two-way communication interface 125 may transmit lading information to the secure facility server. The lading information may include information related to the shipper/recipient of goods (and the carrier of the goods if different from the shipper) as well as the type, quantity and destination of the goods and whether such goods are being picked up or delivered. The secure facility server 105 evaluates whether the lading information is valid based on predetermined delivery/pickup information. The predetermined delivery/pickup information may include information regarding the deliveries expected, the goods expected, the times the goods are expected (or alternately what goods are to be picked up and by whom) and other information corresponding to the lading information.

If the lading information is confirmed by the secure facility server 105, the secure facility server 105 transmits instructions to the delivery vehicle system 110 as well as sending an instruction to open the security gate to allow the delivery vehicle 100 into the secure facility. The instructions may designate a location or may include, for example, how and where to proceed within the facility to deliver or pick up the goods. Where the internal layout of the facility is not available through normal navigational maps, the instructions may include a map that may be either displayed to the operator of the delivery vehicle 100 or conveyed directly to the processing/memory device 130 so that delivery vehicle 100 may proceed to a designated location in an autonomous mode.

In response to receiving valid lading information, the instructions may direct delivery vehicle 100 to a designated location, such as an unloading/loading area, for example a loading dock, or to a waiting area such as a parking area or temporary holding area. A waiting area may be selected when this may reduce congestion in the secure facility. Secure facility server 105 is aware that the unloading/loading areas is not available. Rather than sending the delivery vehicle to an unavailable unloading/loading area the secure facility server may direct the delivery vehicle 100 to a waiting area where the delivery vehicle 100 will wait until again instructed by the secure facility server 105 to proceed to the unloading/loading area.

FIG. 2 is a block diagram of an example delivery vehicle system 110 that may be incorporated into the delivery vehicle 100. In general, the delivery vehicle system 110 may facilitate the two-way communication with the secure facility server and may help the driver to navigate to a designated location. The delivery vehicle system 110, as shown, includes a user interface device 115, a navigation system 120, a two-way communication interface 125, a processing/memory device 130 and a security key transmitter 140. Some or all of these components may be incorporated into the delivery vehicle's 100 infotainment system. Alternatively, some or all of the components may be incorporated into one or more stand-alone devices in communication with one another. For instance, the user interface device 115 and navigation system 120 may be part of the infotainment system while the two-way communication interface 125 and processing/memory device 130 may be incorporated in a dongle or a mobile device such as a cell phone or tablet computer. Security key transmitter 140 may be a proximity sensor and may be positioned external to the delivery vehicle 100 to facilitate near field communication.

The user interface device 115 may be configured to present information to a vehicle occupant. Moreover, the user interface device 115 may be configured to receive user inputs. Examples of user inputs may reflect the goods to be delivered to a specific secure facility where a delivery vehicle is making multiple stops. Alternately a user input may include any change to the lading information, for example a change in carrier, or may include any last minute instructions from the shipper. In the event that either the security key or lading information is not authenticated, secure facility server may transmit questions which may be displayed to the vehicle occupant so that proper security information may be obtained.

The navigation system 120 may be configured to determine a current location of the delivery vehicle 100. The navigation system 120 may include a Global Positioning System (GPS) receiver configured to triangulate the position of the delivery vehicle 100 relative to satellites or terrestrial based transmitter towers. Location information from the navigation system 120 may identify that the delivery vehicle 100 is at a specific secure facility. The information about the specific secure facility may conveyed by navigation system 120 to processing/memory device 130 so that the relevant lading information may be transmitted by two-way communication interface 125.

The navigation system 120 may be configured to further develop routes to the designated area transmitted by the secure facility server 105. As discussed above, upon transmission of the designated area, whether it be the loading dock or a waiting area, the navigation system 120 may develop directions. Alternately, the instructions may include a route from the security gate which may include turn-by-turn directions. A map and turn-by-turn directions may be output to the occupant of the delivery vehicle 100 via, e.g., the user interface device 115. The delivery vehicle may proceed in an autonomous mode to the designated location.

The two-way communication interface 125 may be configured to facilitate wired and/or wireless communication between the components of the vehicle and other devices, such as the secure facility server 105. The two-way communication interface 125 may also be configured to communicate directly with a mobile device using any number of communication protocols such as Bluetooth®, Bluetooth® Low Energy, or WiFi. Accordingly, the two-way communication interface 125 may be configured to send information to the secure facility server 105. As described above the information may include the lading information. The two-way communication interface 125 may be configured to receive information transmitted by the secure facility server 105.

The processing/memory device 130 may be configured to store information and process signals. This may include the user inputs received via the user interface device 115, signals output by the navigation system 120, and instructions received from the secure facility server 105. The processing/memory device 130 may be configured to determine how far the delivery vehicle 100 is from the designated area. For instance, the processing/memory device 130 may determine the distance from a difference between the current location of the delivery vehicle 100 and the designated area based on signals output by the navigation system 120. The distance may be presented spatially (e.g., in kilometers) or temporally (e.g., minutes from the designated area).

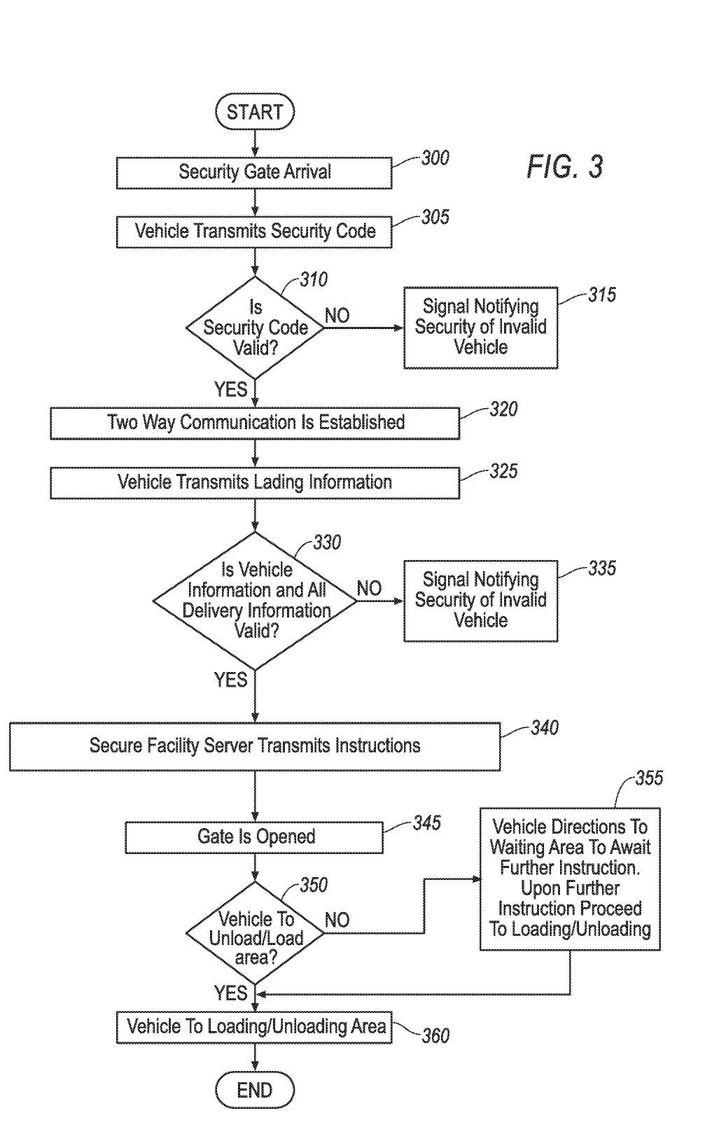

FIG. 3 is a flowchart of an example process that may be implemented by one or more components of the delivery vehicle system 110. At block 300 the delivery vehicle arrives at the security gate for the secure facility. As noted above, the navigation system 120 may recognize that the delivery vehicle 100 has arrived at the secure facility and select a security key specific to that facility which may be transmitted by security key transmitter 140.

At block 305 security key transmitter 140 transmits a security key to the secure facility server. Transmissions may be active or passive. At block 310 the secure facility server determines whether the security key is valid. If the security key is not valid, the secure facility server may alert on-site security at the secure facility as noted at block 315.

Where the security key is valid two-way communication is established at block 320. At block 325 and upon establishing two-way communication with the delivery vehicle 100, the two-way communication interface 125 transmits the lading information to the secure facility server 105. At block 330 the secure facility server verifies the lading information using predetermined delivery/pickup information from the secure facility server. For example, the secure facility has information regarding goods that are expected for delivery, as well as the shippers and carriers for the goods. If the lading information is not valid on-site security is alerted at block 335.

At block 340 the secure facility server 105 transmits instructions to the delivery vehicle 100. The instructions may include information regarding the location to which the delivery vehicle should proceed, for example an unloading/loading area or a waiting area. The delivery/pickup information may also include route information. Once the instructions have been provided to the delivery vehicle 100 the gate at the secure facility may be opened as noted at block 345 so that the delivery vehicle may proceed into the secure facility.

At block 350 the secure facility server queries whether the delivery vehicle 100 has been instructed to proceed to an unloading/loading area or to a parking or waiting area. As noted above the secure facility server may not direct the delivery vehicle to an unloading/loading area if the an unloading/loading area is occupied or otherwise not prepared to receive the goods or deliver the goods in the case of a pickup. If the delivery vehicle has been directed to a waiting area, the secure facility server again communicates with the delivery vehicle and transmits delivery/pickup information when the unloading/loading area is available. At block 360 the delivery vehicle arrives at the unloading/loading area where the secure facility server may again transmit information regarding unloading or loading of the goods. Similarly, when the delivery vehicle 100 arrives at the unloading/loading area two-way communication interface 125 may alert the secure facility server 105 the delivery vehicle has arrived so that any necessary steps may be taken.

In general, computing systems and/or devices discussed above may employ any of a number of computer operating systems, including, but by no means limited to, versions and/or varieties of the Ford Sync® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, an on board vehicle computer, a computer workstation, a server, a desktop, notebook, laptop, or handheld computer, or some other computing system and/or device.

Computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media.

A computer readable medium (also referred to as a processor readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A vehicle system, comprising:
a security key transmitter configured to transmit a security key
a two-way communication interface establishing a two-way communication with a secure facility server in response to a valid security key;
a processing/memory device having stored lading information; the stored lading information being transmitted to the secure facility server and the processing/memory device configured to receive instructions from the secure facility server.

2. A vehicle system as in claim 1 where the security key is transmitted with a proximity sensor.

3. A vehicle system as in claim 1 where the two-way communication is a Bluetooth® communication.

4. A vehicle system as in claim 1 where the lading information provides vendor information and identifies goods being delivered.

5. A vehicle system as in claim 4 where the instructions define delivery/pickup information when the vendor information and goods match predetermined delivery/pickup information.

6. A vehicle system as in claim 5 where the delivery/pickup information identifies an unloading location.

7. A vehicle system as in claim 5 where the two-way communication interface alerts the secure facility server when the vehicle arrives at an unloading location.

8. A vehicle system as in claim 7 where the instructions include routing information.

9. A vehicle system as in claim 7 where a navigation system calculates routing information.

10. A method comprising:
transmitting a security key from a delivery vehicle system to a secure facility server;
establishing two-way communication between the delivery vehicle system and a secure facility server in response to a valid security key;
transmitting lading information from the delivery vehicle system to the secure facility server;
receiving instructions from the secure facility server where the lading information is validated by the secure facility server.

11. A method as in claim 10 where the security key is transmitted with a proximity sensor.

12. A method as in claim 11 where on-site security is alerted where the security key is not validated.

13. A method as in claim 10 where the lading information provides vendor information and identifies goods being delivered.

14. A method as in claim 13 where the secure facility server only provides instructions when the lading information and goods match predetermined delivery/pickup information.

15. A method as in claim 13 where on site security is alerted where the secure facility server determines that the lading information does not match a predetermined delivery pickup/information.

16. A method as in claim 14 where the instructions identify an unloading location.

17. A method as in claim 14 where the instructions identify a waiting area.

18. A method as in claim 17 where the secure facility provides additional instructions that identify an unloading location after the delivery vehicle has waited in the waiting area for a predetermined period of time.
